(19) United States
(12) Patent Application Publication
(10) Pub. No.: US 2026/0203203 A1
(43) Pub. Date: Jul. 16, 2026

(54) TESTING SOFTWARE ON RESOURCE-CONSTRAINED COPROCESSORS

(71) Applicant: Honeywell International Inc., Charlotte, NC (US)

(72) Inventors: Suresh Kumar Golivi, Bangalore (IN); Aralakuppe Ramegowda Yogesha, Bangalore (IN); Harsha Subbarayappa, Bangalore (IN); V V Satyanarayana Chandabattula, Bangalore (IN)

(73) Assignee: Honeywell International Inc., Charlotte, NC (US)

(21) Appl. No.: 19/179,913

(22) Filed: Apr. 15, 2025

(30) Foreign Application Priority Data
Jan. 16, 2025 (IN) 202511003668

(51) Int. Cl. G06F 11/3698; G06F 9/54

(52) U.S. Cl. CPC G06F 11/3698; G06F 9/544

(57) ABSTRACT

Systems and methods for testing software on resource-constrained coprocessors are described herein. In certain embodiments, a system includes a primary processor. The system also includes a secondary processor. Further, the system includes one or more shared memories, wherein the one or more shared memories are directly accessible to both the primary processor and the secondary processor. Additionally, the primary processor provides testing inputs to the secondary processor through the one or more shared memories, and the primary processor retrieves testing outputs from the one or more shared memories.

### CROSS-REFERENCE TO RELATED APPLICATIONS

This application claims benefit of Indian Provisional Application No. 202511003668, filed on Jan. 16, 2025, and titled “TESTING SOFTWARE ON RESOURCE-CONSTRAINED CO-PROCESSORS,” the contents of which are incorporated herein by reference in their entirety.

### BACKGROUND

Many mechanical and electrical systems include one or more embedded systems to perform dedicated functions for the larger system. In particular, embedded systems are specialized computing systems designed to perform one or more dedicated functions for encompassing systems. Often, embedded systems, tailored to perform specific tasks, are built into many devices that are used daily in many applications across many industries. For example, embedded systems may be employed in consumer electronics, transportation systems, telecommunications, and automation, among many other applications.

Frequently, embedded systems consist of hardware (like microcontrollers or processors) and software (firmware) and may also include sensors and actuators to acquire information or interact with the environment. The components used to deploy embedded systems can be optimized for specific tasks, leading to faster processing, reduced power consumption, space-saving, and cost-effectiveness. Further, embedded systems can process data, respond to information, and control signals in real time, enabling systems to perform tasks within applications that rely on near-immediate feedback.

Often, the processors perform vital roles within embedded systems as they function as the core computing unit where application software executes. Some embedded systems may include one or more primary processors and one or more coprocessors. The primary processors may run application software that controls one or more associated devices, and the coprocessors may work alongside the primary processors to perform real-time and other complex tasks.

### SUMMARY

Systems and methods for testing software on resource-constrained coprocessors are described herein. In certain embodiments, a system includes a primary processor. The system also includes a secondary processor. Further, the system includes one or more shared memories, wherein the one or more shared memories are directly accessible to both the primary processor and the secondary processor. Additionally, the primary processor provides testing inputs to the secondary processor through the one or more shared memories, and the primary processor retrieves testing outputs from the one or more shared memories.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIG. 1 is a block diagram of an embedded system processor according to an aspect of the present disclosure; and

FIG. 2 is a block diagram illustrating the flow of information between components of an embedded system processor when testing software on resource-constrained processors according to an aspect of the present disclosure; and

FIG. 3 is a flowchart diagram of a method for testing software on resource-constrained coprocessors according to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

In the typical design and architecture of embedded systems, an embedded system may include an embedded system processor having one or more cores that execute an embedded application that causes the embedded system to perform particular tasks in service of a larger system. Some embedded systems may be part of systems that require certification of all software executing within a system, including the certification of software executed by cores of embedded system processors. For example, within the aerospace industry, software may be subject to mandatory certification requirements that apply to all software executing on the aircraft. Accordingly, it is important to ensure that the software executed by cores of an embedded system processor complies with the defined requirements and satisfies code coverage, where every line of executed code is exercised according to the defined requirements. Code coverage requirements ensure that there is no unintended code in the executed software.

When code coverage requirements are tested for a normal processor, there is typically hardware in place that is testable. Also, normal processors may be tested using test software and other testing systems. For example, test software may run on a desktop computer or other test device that is connected to the hardware through compatible interfaces and connections. After connecting the test device, software can be loaded on the target hardware, where tests can be run based on specific requirements. The tests can include transmitting test inputs from the test device through the connection interface to the target hardware executing the loaded software. Then, the data from the test device are collected and analyzed to ensure that the loaded software satisfies the code coverage requirements.

However, some embedded systems may perform tasks that are subject to extreme time-critical functionality requirements. For example, some embedded systems may control high-speed switching frequency gate drives that require control software that can operate at substantially high speeds. Often, embedded systems that rely solely on main or principal cores of an embedded system processor may be unable to meet timing requirements for the embedded system. In such situations, the embedded system processor may support a secondary processor, core, or coprocessor that executes code to support the operation of the primary processor. For example, some embedded system processors include control law accelerators (CLA) that execute code in addition to and in support of the main processor. Embedded system processors that include secondary cores are able to execute tasks simultaneously, effectively distributing time-critical functionalities as duties are parallelized to meet stringent timing requirements, like those associated with switching frequency gate drives.

However, embedded systems processors with secondary cores introduce complexity with regards to certifying the executing software, as the software executed by the secondary cores must also be tested to ensure compliance with the necessary standards, like standards associated with code coverage. In particular, secondary cores introduce complexity because, in contrast to the primary core that can connect to external systems through communication interfaces, secondary cores or CLAs lack access to communication interfaces with external systems. Accordingly, a secondary core is isolated and can often only interact with the primary core through shared memory. Thus, embedded systems lack hardware through which external test systems can communicate with the secondary cores. Test systems often include libraries that are necessary for testing. Thus, traditional test systems are unable to collect tracing and coverage data.

In certain embodiments, systems and methods are able to perform tracing and coverage data for software executed by the secondary core. In particular, the embedded system processor includes a shared memory and a global memory. The shared memory is a memory that is accessible to both a primary core and an associated secondary core. The global memory is a memory that is accessible to the primary processor but inaccessible to the secondary core. Further, data stored in the global memory may be accessible to external systems through an external interface. The external interface may also be directly coupled to the primary core. The primary core may be configured to support a set of instructions for performing file operations or other actions. However, the secondary core supports the operation of the primary core but does not support the set of instructions for performing file operations.

In exemplary embodiments, to perform tracing and evaluate code coverage, the primary core may provide testing inputs to the secondary core through the shared memory. The secondary core will receive the testing inputs and execute software instructions using the testing inputs. As the executing software generates outputs that include test results and structural coverage data, the secondary core stores the outputs in the shared memory. When the test is complete, the secondary core sends an acknowledgment to the primary core. In response to the acknowledgment, the primary core retrieves the generated outputs from the shared memory, stores the outputs in the global memory, and indicates to an external system or a test harness that the generated outputs are available for retrieval on the global memory. The external system then accesses the generated outputs in the global memory through the external interface. The external system can then analyze the generated outputs to determine whether the code executed by the secondary core conforms with code coverage requirements.

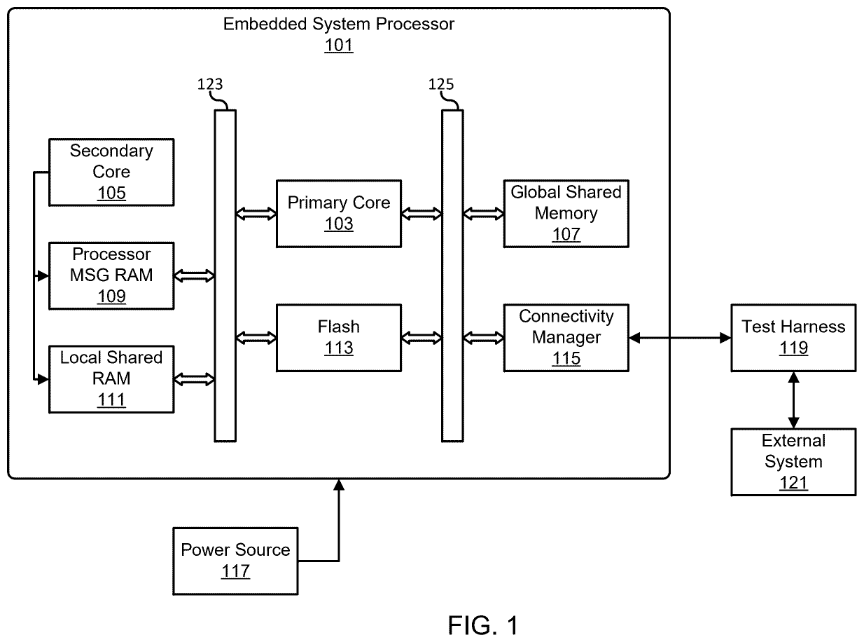

FIG. 1 is a block diagram of an embedded system processor 101 having a primary core 103 and a secondary core 105. While the embedded system processor 101 is shown as having at least one primary core 103 and associated secondary core 105, the embedded system processor 101 may include multiple sets of additional primary cores and associated secondary cores or may include multiple standalone cores. In some implementations, the embedded system processor 101 may function as a digital signal processor (DSP), microprocessor, or other device or circuitry capable of performing the desired functions within an embedded system processor. Further, the embedded system processor 101 may receive power from a power source 117, which functions in a similar manner to power sources generally.

In certain embodiments, the primary core 103 includes circuitry for executing software instructions. For example, the primary core 103 may include fixed-point and floating-point processing circuitry. Also, the primary core 103 may include trigonometric math units to facilitate the calculation of trigonometric math functions. The primary core 103 may further include circuitry for performing integrity checks for data, like various cyclical redundancy checks. Also, the primary core 103 may include circuitry and libraries to handle timing, interrupts, booting, analysis, diagnostics, and other functionality. The primary core 103 may also include various memories that can function to provide data for processing, aid in device booting, and facilitate communication between different components in the embedded system processor 101. For example, the primary core 103 may include flash memory 113. Further, the memories associated with the primary core 103 may include libraries that allow the primary core 103 to execute code and also facilitate the evaluation of the code with regard to code coverage requirements.

In additional embodiments, the primary core 103 is able to communicate with external systems through a connectivity manager 115. To facilitate communications through the connectivity manager 115, the primary core 103 may communicate with the connectivity manager 115 through a global bus 125. The global bus 125 is a connection within the embedded system processor 101 through which components in the embedded system processor 101 can communicate with the connectivity manager 115. Accordingly, components connected to the global bus 125 may be accessed by external systems through the connectivity manager 115, which can communicate with components connected to the global bus 125. While the embedded system processor 101 shows some of the devices connected to a global bus 125, the global bus 125 includes any circuitry or other structures that can facilitate connecting different components for communication through the connectivity manager 115.

In some embodiments, the embedded system processor 101 may also include a global shared memory 107, which is connected to the global bus 125. The global shared memory 107 includes memory storage structures through which components connected to the global bus 125 can store data. Additionally, the global shared memory 107 may be accessible to external systems through the connectivity manager 115. For example, the primary core 103 may store data in the global shared memory 107, and then external systems may access the data stored by the primary core 103 in the global shared memory 107 through the connectivity manager 115.

In further embodiments, the embedded system processor 101 may include a secondary core 105 that supports the operation of the primary core 103. For example, the secondary core 105 may be a control law accelerator (CLA) in a DSP processor. When the secondary core 105 is a CLA, the secondary core 105 is designed to handle tasks related to control algorithms with better precision and efficiency than a more generally capable processor like the primary core 103. In larger systems that employ the embedded system processor 101, a CLA may enable the embedded system processor 101 to meet demands for faster execution times. For example, when a larger system employs high-speed switching frequency gate drives, the larger system may demand faster control loop execution times to operate efficiently. Accordingly, the secondary core 105 may be employed to support the primary core 103 by offering parallel processing capabilities that are able to handle specific calculations simultaneously with the primary core 103. In some implementations, the secondary core 105 may be optimized for performing real-time control tasks at faster execution speeds than the primary core 103.

In certain embodiments, the secondary core 105 may communicate with the primary core 103 through a local bus 123. The local bus 123 may enable the exchange of signals and data between the secondary core 105 and primary core 103, where the exchange of signals and data supports the execution of processes performed by the primary core 103 in conjunction with the secondary core 105. For example, the operation of the secondary core 105 may be supported by and directly coupled to and able to directly access a processor message RAM 109 and a local shared RAM 111. The processor message RAM 109 is connected to the local bus 123 and enables the exchange of messages between the secondary core 105 and the primary core 103 through the local bus 123. The local shared RAM 111 is connected to the local bus 123 and enables the exchange of data between the secondary core 105 and the primary core 103. While the local bus 123 is described as a bus, it can be any combination of circuitry that enables the exchange of data and messages between the secondary core 105 and the primary core 103. As the local shared RAM 111 and the processor message RAM 109 are both accessible to the primary core 103 and the secondary core 105, the local shared RAM 111 and the processor message RAM 109 may function as shared memories for the primary core 103 and the secondary core 105.

In some embodiments, the secondary core 105 may lack access to communication interfaces through which test software can be efficiently downloaded and through which test results and coverage data can be retrieved by external systems for certification purposes. Further, the secondary core 105 lacks some of the computational resources used by the primary core 103. For example, the secondary core 105 may lack built-in support for libraries that are often used for executing tests and collecting data. Further, the secondary core 105 may lack a flash memory that can store control software for performing tests to evaluate structural coverage data. While using a secondary core 105 (like a CLA) may offer significant benefits for achieving high-speed control, the limitations of the secondary core 105 pose difficulties for implementing testing and certification of software executed by the secondary core 105.

In one example of an embedded system processor 101 implementing a CLA as a secondary core 105, the CLA may be employed within a DSP (like a TI DSP). In such a CLA, the CLA may only be able to execute code through an external interrupt from a primary core 103. Thus, the source code executed by the secondary core 105 may be part of interrupt service routines. Further, the secondary core 105 may have limited RAM and lack support for standard I/O libraries. Additionally, the secondary core 105 may lack support for initialized global and static data and may need to handle initialized variables manually through initialization tasks. Moreover, the secondary core 105 may lack support for recursive function calls, function pointers, and some memory functions (like malloc( )).

In certain embodiments, a test harness 119 may be employed that enables an external system 121 to perform configuration, testing, and certification of software executed by the secondary core 105. For example, the test harness 119 may load configuration information along with a test driver application to execute on the primary core 103 that interacts with the secondary core 105 through the processor message RAM 109. In particular, the test harness 119 may load a test driver application into the flash memory 113, which provides configuration information, testing inputs, and triggers to initialize the execution of tests on the secondary core 105. Further, the secondary core 105 may store testing outputs that include results and coverage data produced by the secondary core 105 when executing software using the test inputs stored in the local shared RAM 111. The primary core 103 may then retrieve the testing outputs that include at least one of the results and the coverage data from the local shared RAM 111. In some implementations, the secondary core 105 may store different portions of the testing outputs in different memories. For example, the secondary core 105 may store the test results in the processor message RAM 109 and the coverage data in the local shared RAM 111.

The primary core 103 may compare the retrieved test results and coverage data with expected outputs and determine whether the execution of the software passed the test. In some embodiments, the primary core 103 may store the determination of test success (pass/fail) in the global shared memory 107. Also, the primary core 103 may store the test results and coverage data in the global shared memory 107. The test harness 119 may then read or retrieve the determination and/or test results stored in the global shared memory 107 through the connectivity manager 115. The test harness 119 may then provide retrieved information from the global shared memory 107 for further analysis by the external system 121.

In some embodiments, the process for developing the test harness 119 may include a software component and a test driver that can be developed with other software programs that are capable of initializing the primary core 103 and the secondary core 105 without activating other potential cores in the embedded system processor 101 and the connectivity manager 115. Further, the test harness 119 may configure the primary core 103 to become the controller of the global shared memory 107 and the local shared RAM 111. Additionally, memory sectors in the local shared RAM 111 may be initialized and allocated to program and data sections of the source code executed by the secondary core 105. Moreover, the processor message RAM 109 may be configured to facilitate messages sent from the primary core 103 to the secondary core 105 to drive test inputs and messages sent from the secondary core 105 to the primary core 103 and messages sent from the primary core 103 to the secondary core 105 for reading the outputs generated by the secondary core 105.

Further, the test harness 119 may define the secondary core 105 tasks executed by the primary core 103 that are executed when an interrupt gets triggered by the execution of software by the primary core 103. For example, the secondary core 105 tasks may be configured as interrupt service routines for supported interrupts. Additionally, a table may be configured with interrupts that trigger the execution of code on the secondary core 105 from the primary core 103. The primary core 103 may also map test case inputs and test case outputs in the processor message RAM 109. Moreover, the test case inputs may be initialized by the primary core 103.

Additionally, the primary core 103 may trigger secondary core 105 tasks and then wait for an acknowledgment from the secondary core 105 that indicates that the interrupt has been completed. Upon completion of the test, the secondary core 105 may store the test outputs in the processor message RAM 109. For example, the secondary core 105 may store the test outputs in the processor message RAM 109 upon completion of execution of an interrupt service routine. When the test results are stored in the processor message RAM 109, the primary core 103 may copy the test results from the processor message RAM 109 into the global shared memory 107. Additionally, the secondary core 105 may store structural coverage data (like a structural coverage hit map) in the local shared RAM 111. The primary core 103 may then copy the structural coverage data stored in the local shared RAM 111 into the global shared memory 107.

Moreover, when the test results and structural coverage data are stored in the global shared memory 107, the primary core 103, test harness 119, or external system 121 may invoke a results analyzer module that determines whether the test passed or failed based on the test results and structural coverage data stored in the global shared memory 107. For example, the primary core 103 may execute code associated with a results analyzer to analyze the results and structural coverage data to determine test status that indicates whether one or more tests have passed. After analyzing the results, the primary core 103 may provide the test status and/or structural coverage data in the global shared memory 107 to the external system 121 through the connectivity manager 115 and test harness 119. The external system 121 may then process the information received from the embedded system processor 101 and represent the structural coverage data and test status in a manner that is usable by users or another analysis system. For example, the host application may process the information and generate an HTML representation of the data or other data that can be represented to a user.

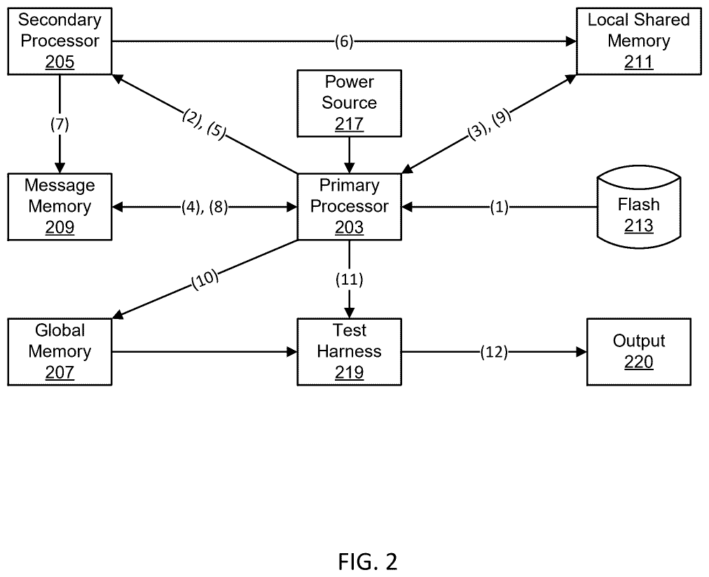

FIG. 2 is a block diagram of various information flows between different components within the embedded system processor 101 in FIG. 1. As illustrated, FIG. 2 shows a primary processor 203 and a secondary processor 205 that respectively correspond to the primary core 103 and the secondary core 105. Also, FIG. 2 shows a power source 217 and a test harness 219 that respectively correspond to the power source 117 and the test harness 119. Further, the shared memory 207, message memory 209, local shared memory 211, and flash 213, respectively, correspond to the global shared memory 107, processor message RAM 109, local shared RAM 111, and flash memory 113 in FIG. 1.

In certain embodiments, an executable file may be fabricated from structural coverage instrumented source files for the secondary processor 205 and test harness files. The executable file may be loaded onto the flash 213, and software executing on the processor or controlling the processor may load a portion of the executable file executed by the secondary processor 205. By loading the executable file onto the flash 213, the data may (1) initialize the primary processor 203 for performing subsequent tests. After initializing the primary processor 203, the primary processor 203 may then prepare the secondary processor 205 by (2) initializing the program and data sections in the memory of the secondary processor 205.

In further embodiments, after initializing the memory associated with the secondary processor 205, the primary processor 203 may (3) load an instrumented program for the secondary processor 205 into the local shared memory 211. Also, the primary processor 203 may (4) then write test inputs into the message memory 209. After writing the test inputs into the message memory 209, the primary processor 203 may (5) trigger an interrupt service routine on the secondary processor 205, where the secondary processor 205 uses the test inputs stored in the local shared memory 211 as inputs for the interrupt service routines. After sending the trigger, the interrupt service routine executed on the primary processor 203 enters a waiting state, where the interrupt service routine waits in a for loop for the reception of a task completion acknowledgment flag.

In additional embodiments, the secondary processor 205 may (6) execute tasks defined for the triggered interrupt service routing using the inputs stored in the local shared memory 211 and dumps structural coverage data (like a structural coverage HIT map) into the local shared memory 211. Further, once the secondary processor 205 completes the execution of the task, the secondary processor 205 may (7) store outputs of the executed task in the message memory 209. Also, the secondary processor 205 may send an acknowledgment to the primary processor 203 indicating that the interrupt service routine has completed execution. Upon receiving the acknowledgment, the primary processor 203 may (8) then read the outputs from the executed task stored in the message memory 209. The primary processor 203 may (9) copy the structural coverage data stored in the local shared memory 211 into the shared memory 207. Also, the primary processor 203 may (10) copy the outputs read from the message memory 209 into the shared memory 207. When the coverage data and outputs are stored in the shared memory 207, the primary processor 203 may (11) call the test harness 219 to determine the pass/fail status based on the outputs and coverage data stored in the shared memory 207. After determining the pass/fail status, the pass/fail status may (12) be provided as output 220 to an external system or host machine. Also, the output 220 provided to the external system or host machine may include the structural coverage data. The external system or host machine may then use the pass/fail status and the structural coverage data to perform required certification on software executed by the secondary processor 205.

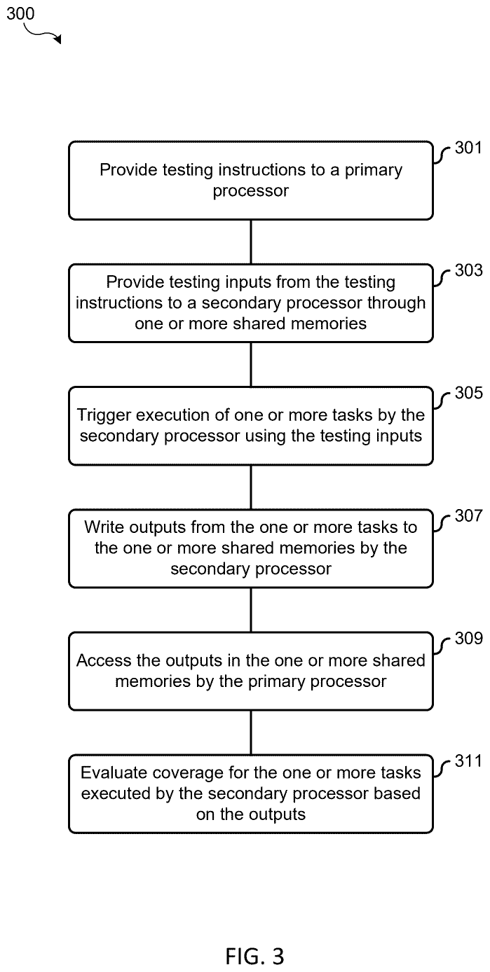

FIG. 3 is a flowchart diagram of a method 300 for testing software on resource-constrained coprocessors. The method 300 proceeds at 301, where testing instructions are provided to a primary processor. For example, a testing harness may connect to an external interface for a system having at least one set of coprocessors. The testing harness may then provide testing instructions to the primary processor through the external interface. The testing instructions and associated information may be stored in a memory on the system that is accessible by the primary processor. Further, the method 300 proceeds at 303, where testing inputs from the testing instructions may be provided to a secondary processor through one or more shared memories. For example, the secondary processor may not have access to the testing instructions provided to the primary processor. Accordingly, the primary processor may store testing inputs from the testing instructions in shared memories like a shared message RAM, where the shared message RAM is accessible to the secondary processor.

In additional embodiments, the method 300 proceeds at 305, where execution of one or more tasks by the secondary processor using the testing inputs may be triggered. For example, the primary processor may trigger an interrupt that causes the secondary processor to execute one or more interrupt service routines using the testing inputs as inputs for the interrupt service routines. Also, the method 300 proceeds at 307, where outputs from the one or more tasks are written to the one or more shared memories by the secondary processor. For example, the secondary processor may write results generated by the executed tasks to a shared message memory and coverage data to a shared memory. Alternatively, the secondary processor may write data to the same memory. Moreover, the method 300 proceeds at 309, where the outputs in the one or more shared memories may be accessed by the primary processor. For example, the secondary processor may signal the primary processor that the secondary processor has completed execution. Upon receiving the indication of completion, the primary processor may retrieve the results and coverage data stored in the shared memory. Additionally, the method 300 proceeds at 311, where coverage for the one or more tasks executed by the secondary processor may be evaluated based on the outputs. For example, either the primary processor may analyze the results or the primary processor may provide the results to an external system through an external interface, where the results may be evaluated to determine whether software executed by the secondary processor satisfies coverage requirements.

### Example Embodiments

Example 1 includes a system comprising: a primary processor, a secondary processor; and one or more shared memories, wherein the one or more shared memories are directly accessible to both the primary processor and the secondary processor; wherein the primary processor provides testing inputs to the secondary processor through the one or more shared memories, and the primary processor retrieves testing outputs from the one or more shared memories.

Example 2 includes the system of Example 1, further comprising an external interface directly coupled to the primary processor, wherein the secondary processor is not accessible through the external interface.

Example 3 includes the system of Example 2, further comprising a connectivity manager configured to manage communications through the external interface.

Example 4 includes the system of any of Examples 2-3, wherein the testing outputs are accessible to external systems through the external interface.

Example 5 includes the system of Example 4, wherein at least one external system functions as a test harness, wherein the test harness is configured to perform at least one of: accessing the testing outputs; analyzing the testing outputs; and providing configuration information to the primary processor.

Example 6 includes the system of any of Examples 1-5, further comprising a global memory directly coupled to the primary processor, wherein the primary processor is further configured to store the testing outputs in the global memory.

Example 7 includes the system of any of Examples 1-6, wherein the primary processor is configured to support a set of instructions for performing file operations, and the secondary processor is not configured to support the set of instructions for performing the file operations.

Example 8 includes the system of any of Examples 1-7, wherein the primary processor and the secondary processor are configured to control a high-speed switching frequency gate drive.

Example 9 includes the system of any of Examples 1-8, wherein the primary processor analyzes the testing outputs.

Example 10 includes the system of any of Examples 1-9, further comprising a flash memory, wherein the flash memory is accessible by the primary processor, wherein the primary processor is configured to access the flash memory, wherein testing instructions are provided to the primary processor through the flash memory.

Example 11 includes the system of any of Examples 1-10, wherein the primary processor is configured to provide the testing inputs by triggering an interrupt, wherein the secondary processor is configured to execute one or more interrupt service routines in response to the triggered interrupt and indicate to the primary processor that the one or more interrupt service routines have completed, wherein the primary processor copies outputs from the one or more interrupt service routines stored in the one or more shared memories as the testing outputs.

Example 12 includes the system of any of Examples 1-11, wherein the secondary processor is configured to store the testing outputs in the one or more shared memories as coverage data in a local shared memory in the one or more shared memories and outputs from instructions executed by the secondary processor in a message memory in the one or more shared memories.

Example 13 includes a method comprising: providing testing instructions to a primary processor; providing testing inputs from the testing instructions to a secondary processor through one or more shared memories; triggering execution of one or more tasks by the secondary processor using the testing inputs; writing outputs from the one or more tasks to the one or more shared memories by the secondary processor; accessing the outputs in the one or more shared memories by the primary processor; and evaluating coverage for the one or more tasks executed by the secondary processor based on the outputs.

Example 14 includes the method of Example 13, wherein providing the testing instructions further comprises storing the testing instructions in a flash memory accessible by the primary processor.

Example 15 includes the method of any of Examples 13-14, wherein triggering the execution of the one or more tasks comprises triggering an interrupt, wherein the secondary processor is configured to execute the one or more tasks as interrupt service routines in response to receiving the interrupt.

Example 16 includes the method of any of Examples 13-15, wherein writing the outputs from the one or more tasks comprises writing coverage data in the outputs into a local shared memory in the one or more shared memories and writing testing outputs in the outputs into a message memory in the one or more shared memories.

Example 17 includes the method of any of Examples 13-16, further comprising: receiving the testing instructions through an external interface; and providing at least one of the outputs and a result of the evaluation of the coverage through the external interface to an external system.

Example 18 includes the method of Example 17, wherein the external system is a test harness connected to the external interface.

Example 19 includes the method of Example 18, wherein the test harness is configured to receive the outputs and evaluate the coverage.

Example 20 includes a system comprising: a primary processor configured to support a set of instructions for performing file operations; a secondary processor, wherein the secondary processor does not support the set of instructions for performing the file operations; a shared memory, wherein the shared memory is directly accessible to both the primary processor and the secondary processor; a global memory directly coupled to the primary processor; and an external interface directly coupled to the primary processor, wherein the secondary processor is not accessible through the external interface; wherein the primary processor provides testing inputs to the secondary processor through the shared memory, and the primary processor retrieves testing outputs and coverage data from the shared memory for storage in the global memory; wherein the testing outputs and the coverage data in the global memory are accessible through the external interface.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a primary processor,
a secondary processor; and
one or more shared memories, wherein the one or more shared memories are directly accessible to both the primary processor and the secondary processor;
wherein the primary processor provides testing inputs to the secondary processor through the one or more shared memories, and the primary processor retrieves testing outputs from the one or more shared memories.

2. The system of claim 1, further comprising an external interface directly coupled to the primary processor, wherein the secondary processor is not accessible through the external interface.

3. The system of claim 2, further comprising a connectivity manager configured to manage communications through the external interface.

4. The system of claim 2, wherein the testing outputs are accessible to external systems through the external interface.

5. The system of claim 4, wherein at least one external system functions as a test harness, wherein the test harness is configured to perform at least one of:
accessing the testing outputs;
analyzing the testing outputs; and
providing configuration information to the primary processor.

6. The system of claim 1, further comprising a global memory directly coupled to the primary processor, wherein the primary processor is further configured to store the testing outputs in the global memory.

7. The system of claim 1, wherein the primary processor is configured to support a set of instructions for performing file operations, and the secondary processor is not configured to support the set of instructions for performing the file operations.

8. The system of claim 1, wherein the primary processor and the secondary processor are configured to control a high-speed switching frequency gate drive.

9. The system of claim 1, wherein the primary processor analyzes the testing outputs.

10. The system of claim 1, further comprising a flash memory, wherein the flash memory is accessible by the primary processor, wherein the primary processor is configured to access the flash memory, wherein testing instructions are provided to the primary processor through the flash memory.

11. The system of claim 1, wherein the primary processor is configured to provide the testing inputs by triggering an interrupt, wherein the secondary processor is configured to execute one or more interrupt service routines in response to the triggered interrupt and indicate to the primary processor that the one or more interrupt service routines have completed, wherein the primary processor copies outputs from the one or more interrupt service routines stored in the one or more shared memories as the testing outputs.

12. The system of claim 1, wherein the secondary processor is configured to store the testing outputs in the one or more shared memories as coverage data in a local shared memory in the one or more shared memories and outputs from instructions executed by the secondary processor in a message memory in the one or more shared memories.

13. A method comprising:
providing testing instructions to a primary processor;
providing testing inputs from the testing instructions to a secondary processor through one or more shared memories;
triggering execution of one or more tasks by the secondary processor using the testing inputs;
writing outputs from the one or more tasks to the one or more shared memories by the secondary processor;
accessing the outputs in the one or more shared memories by the primary processor; and
evaluating coverage for the one or more tasks executed by the secondary processor based on the outputs.

14. The method of claim 13, wherein providing the testing instructions further comprises storing the testing instructions in a flash memory accessible by the primary processor.

15. The method of claim 13, wherein triggering the execution of the one or more tasks comprises triggering an interrupt, wherein the secondary processor is configured to execute the one or more tasks as interrupt service routines in response to receiving the interrupt.

16. The method of claim 13, wherein writing the outputs from the one or more tasks comprises writing coverage data in the outputs into a local shared memory in the one or more shared memories and writing testing outputs in the outputs into a message memory in the one or more shared memories.

17. The method of claim 13, further comprising:
receiving the testing instructions through an external interface; and
providing at least one of the outputs and a result of the evaluation of the coverage through the external interface to an external system.

18. The method of claim 17, wherein the external system is a test harness connected to the external interface.

19. The method of claim 18, wherein the test harness is configured to receive the outputs and evaluate the coverage.

20. A system comprising:
a primary processor configured to support a set of instructions for performing file operations;
a secondary processor, wherein the secondary processor does not support the set of instructions for performing the file operations;
a shared memory, wherein the shared memory is directly accessible to both the primary processor and the secondary processor;
a global memory directly coupled to the primary processor; and
an external interface directly coupled to the primary processor, wherein the secondary processor is not accessible through the external interface;
wherein the primary processor provides testing inputs to the secondary processor through the shared memory, and the primary processor retrieves testing outputs and coverage data from the shared memory for storage in the global memory;
wherein the testing outputs and the coverage data in the global memory are accessible through the external interface.
